(19) United States
(12) Patent Application Publication
(10) Pub. No.: US 2022/0172915 A1
(43) Pub. Date: Jun. 2, 2022

(54) MEDIUM VOLTAGE VACUUM INTERRUPTER CONTACT WITH IMPROVED ARC BREAKING PERFORMANCE AND ASSOCIATED VACUUM INTERRUPTER

(71) Applicant: Schneider Electric Industries SAS, Rueil Malmaison (FR)

(72) Inventors: Mathieu Bono, Miribel Lanchâtre (FR); Anthony Papillon, Proveysieux (FR)

(73) Assignee: Schneider Electric Industries SAS, Rueil Malmaison (FR)

(21) Appl. No.: 17/529,448

(22) Filed: Nov. 18, 2021

(30) Foreign Application Priority Data
Nov. 30, 2020 (FR) FR2012380

(51) Int. Cl. H01H 33/664; H01H 33/666

(52) U.S. Cl. CPC H01H 33/6643; H01H 33/666

(57) ABSTRACT

Electrical switching contact with radial magnetic field for a medium-voltage vacuum interrupter including a rod and a contact body, coaxial to the rod, which includes a disc and a circular element concentric with the disc and arranged protruding on a face of the disc, the other face of the disc being secured to the rod. The contact body has a spiral configuration; the disc includes slits in the thickness of the disc which extends from the periphery of the disc towards the centre of the disc; the circular element has an outer diameter smaller than the diameter of the disc. The disc and the circular element are made of a copper alloy with a refractory metal chosen from among chromium, tungsten and molybdenum, the alloy of the circular element including a proportion by weight of the refractory metal greater than that of the alloy of the disc.

### TECHNICAL FIELD

The invention relates to the field of medium-voltage vacuum interrupters, also called vacuum interrupters. It deals more particularly with enhancing the performance in the closing of such vacuum interrupters.

### STATE OF THE ART

Vacuum interrupters are used in medium-voltage (from 1 to 52 kV) distribution electrical switchgear to cut off short-circuit currents of the order of a few kA, typically 25 kA, with voltages of a few kV, typically 36 kV.

As is known and as illustrated in FIG. 1, a medium-voltage vacuum interrupter 1 is an electrical switching device comprising a jacket 12 extending on a longitudinal axis Y and forming an airtight enclosure, in which there is housed a pair of switching contacts 2, 3 which are mobile with respect to one another (there is generally one moving contact 2 and one fixed contact 3) between an open position (part represented on the right) and a closed position (part represented on the left) by an axial movement by virtue of an actuating rod 13. A screen 14 is also arranged inside the enclosure around the switching contacts 2, 3 to protect the jacket 12 against the effect of arcs established between the contacts. Each switching contact 2, 3 comprises a contact body 6, 7 made of a metal with high conductivity, for example of copper, and mounted coaxially on a rod 4, 5 made of a material with good mechanical strength and high electrical conductivity (that is to say, a conductivity greater than or equal to 98% IACS (International Annealed Copper Standard) such as copper for example; the two rods 4, 5 are arranged in extension with one another. The enclosure is intended to contain an insulating gas and to be set to a vacuum.

To ensure their switching and closure functions, the contact bodies of the switching contacts must be made of a material which satisfies, among other things, the requirements of resistance to electrical voltage, of thermal conductivity and of anti-welding (in order to avoid having the contact bodies of a pair of contacts being welded together). To best satisfy all these requirements, many known materials of the contact bodies of the switching contacts result from the combination of two or more metals. Moreover, it is known that, to break the short-circuit currents in a vacuum interrupter, the arc contacts must be designed such that intense axial magnetic fields (usually referred to as AMF, the abbreviation for “Axial Magnetic Field”) or radial magnetic fields (usually referred to as RMF, the abbreviation for “Radial Magnetic Field”) are generated at the ends of the contacts facing one another, in order to produce a control of the arc upon the mutual separation of the contacts. For the AMF, the fields are generated parallel to the longitudinal axis Y of the vacuum interrupter of FIG. 1, whereas, for the RMF, the fields are created radially with respect to the same axis (that is to say on the axis X in FIG. 1).

In the context of the present invention, the inventors focused on the switching contacts with radial magnetic field (that is to say of RMF type) and sought to enhance the closure performance of this type of contact.

### SUMMARY OF THE INVENTION

For this, the subject of the invention is an electrical switching contact with radial magnetic field for a medium-voltage vacuum interrupter extending on a longitudinal axis Y, the electrical switching contact comprising:
a mechanical connection and current input rod which extends on the longitudinal axis Y; and
a contact body which is coaxial to the rod and which comprises a disc and a circular element, concentric with the disc and arranged protruding on a face of the disc, the other face of the disc being secured to the rod;
characterized in that the contact body has a spiral configuration, the disc comprising slits formed in the thickness of the disc and which extend from the periphery of the disc towards the centre of the disc, and the circular element having an outer diameter smaller than the diameter of the disc, and characterized in that the disc and the circular element are made of a copper alloy with a refractory metal chosen from among chromium, tungsten and molybdenum, the alloy of the circular element comprising a proportion by weight of the refractory metal greater than that of the alloy of the disc. Preferably, the disc and the circular element are made of a copper alloy with the same refractory metal.

Thus, according to the invention, there is a hybrid switching contact with a contact body which comprises a disc and a circular element made of copper alloy of different compositions, the circular element of an alloy that is more refractory than that of the disc. For example, if the alloys are alloys of copper and of chromium, the alloy of the circular element comprises a proportion by weight of chromium greater than that of the alloy of the disc.

To recap, a “spiral” configuration is a well-known particular configuration of an electrical switching contact with radial magnetic field. A typical example of a spiral configuration is illustrated in FIG. 2. Among the other known configurations of an electrical switching contact with radial magnetic field, the “contrate” configuration (also known as “cup contact design”) configuration can also be cited.

As its name indicates, the disc of the contact body is a substantially flat element, the periphery of which is substantially circular. As is known, in a spiral configuration, each slit can be rectilinear or else curved.

According to a first embodiment, the disc and the circular element are of an alloy of copper and of chromium, the alloy of the circular element comprising a proportion by weight of chromium greater than that of the alloy of the disc, the proportions by weight of copper in the alloy of the disc being between 50 and 95%, the balance being made up with the chromium, and the proportions by weight of copper in the alloy of the circular element being between 40 and 80%, the balance being made up with the chromium. It is specified that, in the present explanation, the expression “is between . . . and . . . ” be understood to include the bounds.

Preferably, the disc and the circular element being made of an alloy of copper and of chromium, the alloy of the circular element comprises at least 50% by weight of copper. Preferentially, the alloy of the disc comprises 75% by weight of copper and 25% by weight of chromium, and the alloy of the circular element comprises between 50 and 60% by weight of copper, the balance being made up with the chromium. As an example, it is thus possible to have a contact that has a disc made of an alloy containing 75% by weight of copper and 25% by weight of chromium and a circular element made of an alloy containing 50% by weight of copper and 50% by weight of chromium or even an alloy containing 60% by weight of copper and 40% by weight of chromium.

According to a first variant, the circular element is a solid element.

According to a second variant, the circular element is a ring.

With a circular element which is a solid disc, welds are likely to form between the pair of switching contacts, close to their centres, upon the closure of the vacuum interrupter or in the event of a short circuit. These welds remain difficult to break upon the opening of the vacuum interrupter. A circular element which is a ring makes it possible to offset the weld zone to an intermediate diameter and facilitate the dewelding, notably by a lever arm effect upon opening.

Another subject of the invention is a medium-voltage vacuum interrupter comprising at least one electrical switching contact as defined above.

Advantageously, the vacuum interrupter comprises a pair of electrical switching contacts with a fixed contact according to the invention and a moving contact according to the invention. All combinations in the pair of contacts are therefore possible. For example, it is possible to have a pair of contacts with a moving contact with a ring circular element and a fixed contact with a ring circular element; a pair of contacts with a moving contact with a solid circular element and a fixed contact with a solid circular element; a pair of contacts with a moving contact with a ring circular element and a fixed contact with a solid circular element; a pair of contacts with a moving contact with a solid circular element and a fixed contact with a ring circular element, the elements being configured so as to allow a physical contact between the circular elements (ring/ring, ring/solid circular element, solid circular element/solid circular element) of the two contacts.

### BRIEF DESCRIPTION OF THE DRAWINGS

The present invention will be better understood on reading the following description, given in a purely indicative and nonlimiting manner, with reference to the attached drawings in which:

FIG. 1, already described, is a partial vertical cross-sectional view of a medium-voltage vacuum interrupter;

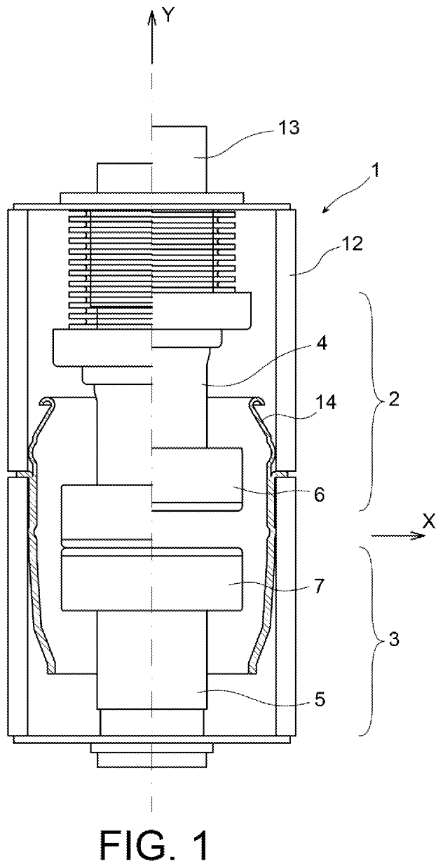

FIG. 2 is a perspective view of a pair of switching contacts according to a first embodiment of the invention;

FIG. 3 is a perspective view of a pair of switching contacts according to a second embodiment of the invention.

### DETAILED DESCRIPTION OF PARTICULAR EMBODIMENTS

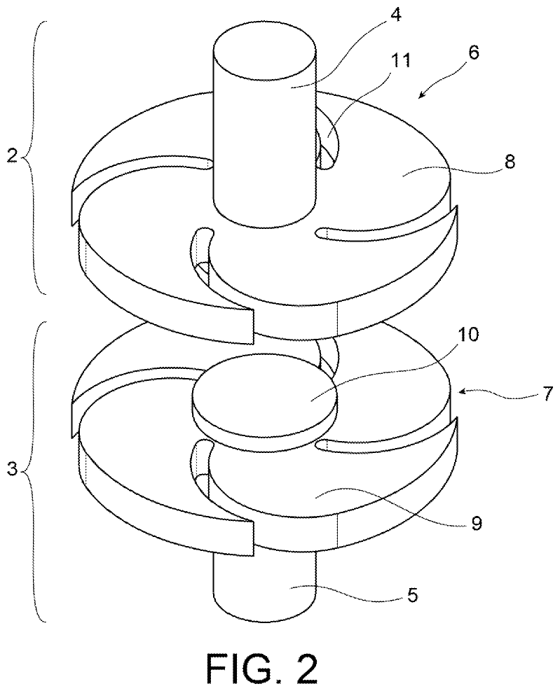

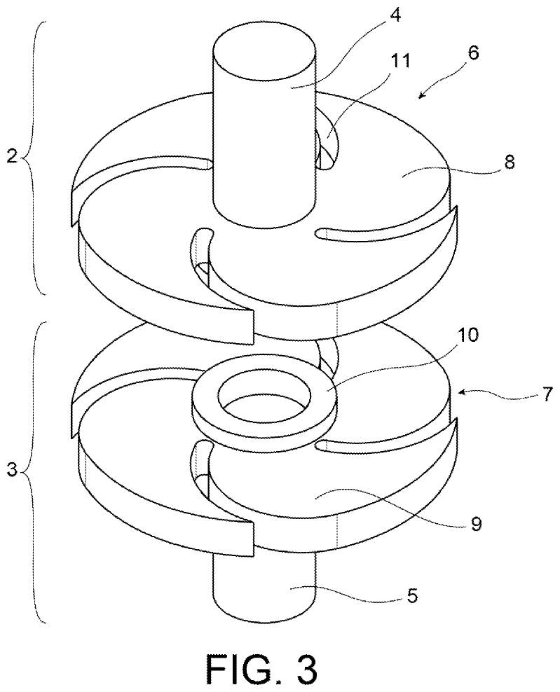

According to the invention, the electrical switching contact is a contact with radial magnetic field and, more specifically, of the spiral type. Examples of this particular spiral configuration are represented in FIGS. 2 and 3. As is known, this spiral configuration is characterized by a contact body comprising a disc provided with slits and a circular element, protruding on a face of the disc having an outer diameter smaller than that of the disc. In FIGS. 2 and 3, four identical slits 11 are formed in spiral-fashion in the disc distributed at 90° from one another along the circumference of the disc and starting from an inner diameter (which can be less than, identical to or greater than the outer diameter of the circular element), to the periphery of the disc. It is perfectly possible to have a different number of slits, for example three slits distributed at 120° from one another along the circumference of the disc. The slits can be curved (as represented in FIGS. 2 and 3) or else rectilinear.

Referring to FIGS. 2 and 3 representing a pair of electrical switching contacts according to the invention, each contact 2, 3 comprises a rod 4, 5 at the end of which is arranged a contact body 6, 7, which is coaxial with the rod 4, 5. Each contact body 6, 7 has a spiral configuration and is provided with a disc 8, 9, one face of which is secured to a rod 4, 5, and with a circular element 10 (only a circular element is visible), arranged protruding on the other of the faces of the disc 8, 9.

As is known from F. Hauner et al., “CuCr for Vacuum Interrupters—Production, Properties and Application”, International Conference on Electrical Contacts, 2008, an electrical switching contact can be produced by different techniques: by sintering, by vacuum arc remelting (VAR method), by vacuum casting, by vacuum-induced melting, by vacuum infusion (the vacuum infusing process or VIP method).

The different parts of the contact are produced separately (rod, disc and circular element) and then assembled.

In the context of the present invention, we have for example produced a vacuum interrupter with two contacts each having a disc made of Cu₇₅Cr₂₅ alloy (% by weight) and a circular element (of pellet or ring type) made of Cu₅₀Cr₅₀ alloy (% by weight) and obtained by VAR. In another example, the circular element (of pellet or ring type) is made of Cu₆₀Cr₄₀ alloy (% by weight) and is obtained by sintering.

1. An electrical switching contact with radial magnetic field for a medium-voltage vacuum interrupter extending on a longitudinal axis, the electrical switching contact comprising:
a mechanical connection and current input rod which extends on the longitudinal axis; and
a contact body which is coaxial to the rod and which comprises a disc and a circular element, concentric with the disc and arranged protruding on a face of the disc, the other face of the disc being secured to the rod;
wherein the circular element is a ring and wherein the contact body has a spiral configuration, the disc comprising slits formed in the thickness of the disc and which extend from the periphery of the disc towards the centre of the disc, and the circular element having an outer diameter smaller than the diameter of the disc, and wherein the disc and the circular element are made of a copper alloy with a refractory metal chosen from among chromium, tungsten and molybdenum, the alloy of the circular element comprising a proportion by weight of the refractory metal greater than that of the alloy of the disc.

2. The electrical switching contact according to claim 1, wherein the disc and the circular element are made of a copper alloy and of chromium, the alloy of the circular element comprising a proportion by weight of chromium greater than that of the alloy of the disc, the proportions by weight of copper in the alloy of the disc being between 50 and 95%, the balance being made up with the chromium, and the proportions by weight of copper in the alloy of the circular element being between 40 and 80%, the balance being made up with the chromium.

3. The electrical switching contact according to claim 2, wherein the alloy of the circular element comprises at least 50% by weight of copper.

4. The electrical switching contact according to claim 3, wherein the alloy of the disc comprises 75% by weight of copper and 25% by weight of chromium, and the alloy of the circular element comprises between 50 and 60% by weight of copper, the balance being made up with chromium.

5. A medium-voltage vacuum interrupter comprising at least one electrical switching contact according to claim 1.

6. A medium-voltage vacuum interrupter, comprising a pair of electrical switching contacts with a moving contact and a fixed contact, wherein each of the moving contact and the fixed contact comprises the electrical switching contact according to claim 1.
